(19) United States
(12) Patent Application Publication
(10) Pub. No.: US 2014/0334824 A1
(43) Pub. Date: Nov. 13, 2014

(54) FIBER OPTIC RECEIVER, TRANSMITTER, AND TRANSCEIVER SYSTEMS AND METHODS OF OPERATING THE SAME

(71) Applicant: US Seismic Systems, Inc., Chatsworth, CA (US)

(72) Inventor: Eric Lee Goldner, Valencia, CA (US)

(73) Assignee: US Seismic Systems, Inc., Chatsworth, CA (US)

(21) Appl. No.: 14/273,776

(22) Filed: May 9, 2014

Related U.S. Application Data
(60) Provisional application No. 61/821,893, filed on May 10, 2013.

(51) Int. Cl. H04B 10/2575

(52) U.S. Cl. CPC H04B 10/2575
USPC 398/116

(57) ABSTRACT

A fiber optic receiver system is provided. The fiber optic receiver system includes: (1) a host node including an optical source for transmitting an optical signal; (2) a remote node away from the host node for receiving the optical signal, the remote node including a radio frequency receiver, the remote node also including a converter for converting the optical signal into an electrical signal, the electrical signal providing electrical power for the radio frequency receiver; and (3) a fiber optic cable between the host node and the remote node, the fiber optic cable including an optical fiber for carrying the optical signal.

### RELATED APPLICATION

This application claims the benefit of priority to U.S. Provisional Patent Application Ser. No. 61/821,893, filed on May 10, 2013, the contents of which are incorporated in this application by reference.

### TECHNICAL FIELD

The present invention relates generally to fiber optic communication systems, and more particularly, to fiber optic communication systems including radio frequency receivers and/or transmitters, and methods of using the same.

### BACKGROUND OF THE INVENTION

Radio frequency (i.e., RF) communications have been in use for many years. In certain environments (e.g., remote locations, mines, etc.), electrical power used to operate such RF communication systems is not available. Therefore, regardless of the desire to utilize RF communication technology, it is often simply not practical or possible.

Thus, it would be desirable to provide improved systems and methods for use of RF communications.

### BRIEF SUMMARY OF THE INVENTION

According to an exemplary embodiment of the present invention, a fiber optic receiver system is provided. The fiber optic receiver system includes: (1) a host node including an optical source for transmitting an optical signal; (2) a remote node away from the host node for receiving the optical signal, the remote node including a radio frequency receiver, the remote node also including a converter for converting the optical signal into an electrical signal, the electrical signal providing electrical power for the radio frequency receiver; and (3) a fiber optic cable between the host node and the remote node, the fiber optic cable including at least one optical fiber for carrying the optical signal as well as other optical signals to and from the remote node(s).

According to another exemplary embodiment of the present invention, a fiber optic wireless transceiver is provided. The fiber optic wireless transceiver includes: (1) a host node; and (2) at least one remote node. The host node includes (a) source and carrier generation optics, (b) one or more optical phase demodulators, and (c) a laser. Each of the at least one remote nodes includes: (a) a radio frequency receiver including a circuit for amplifying high frequency electrical signals and providing impedance matching, and an amplifier; (b) an interferometer including two optical legs, a phase modulator within at least one of the optical legs, and reflectors at a distal end of each of the optical legs; (c) a DC optical-to-electrical power conversion circuit to convert incoming optical power to DC electrical power; and (d) a radio frequency transmitter.

According to another exemplary embodiment of the present invention, another fiber optic wireless transceiver is provided. The fiber optic wireless transceiver includes a host node having (a) source and carrier generation optics, (b) an optical phase demodulator, (c) a laser, and (d) transmission optics. The fiber optic wireless transceiver also includes at least one remote node, where each remote node includes: (a) an electrical radio frequency receiver including a circuit for amplifying high frequency electrical signals and providing impedance matching, and an amplifier; (b) an interferometer including two optical legs, a phase modulator within at least one of the optical legs, and reflectors at a distal end of each of the optical legs; (c) a DC optical-to-electrical power conversion circuit to convert incoming optical power to DC electrical power; (d) a radio frequency transmitter; and (e) a high-speed optical receiver.

According to another exemplary embodiment of the present invention, a fiber optic receiver system is provided. The fiber optic receiver system includes: an optical source for transmitting an optical signal; a radio frequency receiver; and a converter for converting the optical signal into an electrical signal, the electrical signal providing electrical power for the radio frequency receiver.

According to another exemplary embodiment of the present invention, a fiber optic transmission system is provided. The fiber optic transmission system includes: an optical source for transmitting an optical signal; a radio frequency transmitter; and a converter for converting the optical signal into an electrical signal, the electrical signal providing electrical power for the radio frequency transmitter.

According to another exemplary embodiment of the present invention, a method of operating a fiber optic receiver system is provided. The method includes the steps of: (a) transmitting an optical signal to a converter; (b) converting the optical signal to an electrical signal using the converter; and (c) providing electrical power to a radio frequency receiver using the electrical signal.

According to another exemplary embodiment of the present invention, a method of operating a fiber optic transmission system is provided. The method includes the steps of: (a) transmitting an optical signal to a converter; (b) converting the optical signal to an electrical signal using the converter; and (c) providing electrical power to a radio frequency transmitter using the electrical signal.

It is to be understood that both the foregoing general description and the following detailed description are exemplary, but are not restrictive, of the invention.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1 is a block diagram of a fiber optic RF transceiver in accordance with an exemplary embodiment of the present invention;

FIG. 2 is a block diagram of exemplary electro-optic converter and RF receiver elements of the fiber optic RF transceiver of FIG. 1 in accordance with an exemplary embodiment of the present invention;

FIG. 3 is a block diagram of an exemplary source and carrier generation optics element of the fiber optic RF transceiver of FIG. 1 in accordance with an exemplary embodiment of the present invention;

FIG. 4 is a block diagram of an exemplary optical to electrical converter of the fiber optic RF transceiver of FIG. 1 in accordance with an exemplary embodiment of the present invention;

FIG. 5 is a block diagram of an exemplary transmission modulation optics element of FIG. 1 in accordance with an exemplary embodiment of the present invention;

FIG. 6 is a flow diagram illustrating a method of operating a fiber optic receiver system in accordance with an exemplary embodiment of the present invention; and

FIG. 7 is a flow diagram illustrating a method of operating a fiber optic transmission system in accordance with an exemplary embodiment of the present invention.

### DETAILED DESCRIPTION OF THE INVENTION

It is sometimes desirable to detect and/or transmit (or retransmit) wireless radio frequency (RF) signals in regions where electrical power is not available. Ordinarily, optical fiber is unaffected by and insensitive to radio frequency interference (RFI), and is therefore not generally useful as a medium for detecting RF signals.

In accordance with various exemplary embodiments of the present invention, fiber optic communication systems are provided such as fiber optic receiver systems (which may also act as fiber optic transmission systems), fiber optic transmission systems (which may also act as fiber optic receiver systems), and fiber optic transceiver systems. Such systems may be configured to receive and/or transmit radio frequency signals, where the power to operate an RF receiver and/or RF transmitter may be provided by converting an optical signal(s) to a voltage. Further, additional communications may be provided by converting an electrical signal (e.g., an RF electrical signal, a downconverted/baseband electrical signal, etc.) to an optical signal, and transmitting the optical signal to a desired location (e.g., to/from a host node, to/from a remote node), where the optical signal may be further processed and/or retransmitted (e.g., as an electrical signal via a common, wired, electronic/optical communications network).

Communications in such systems (e.g., fiber optic receiver systems, fiber optic transmission systems, and fiber optic transceiver systems) may be accomplished between a host node (e.g., a control center, where the host mode may have access to electrical power) and one or more remote nodes (e.g., where the one or more remote nodes may not have access to electrical power to operate an RF receiver and/or an RF transmitter). Such communications may also be between a plurality of remote nodes.

According to an exemplary embodiment of the present invention, a method is presented whereby an electro-optic system can be used to convert a RF signal (e.g., a high frequency RF signal) into an optical intensity signal that can then be transmitted over long distances (e.g., kilometers) and interrogated, recorded, and retransmitted without the use of locally available electrical power for the detection and retransmission of the wireless signals. According to certain exemplary embodiments, the invention incorporates an all-optical transmission cable to minimize the need for electrical energy transfer and outside detection of signals (e.g., stealth) at least along the cable.

According to certain exemplary embodiments of the present invention, a fiber optic receiver (e.g., a high speed fiber optic wireless transceiver) is provided which includes a fiber optic wireless receiver connected via fiber optic cable to a host node (also referred to as a control center). The host node is also connected to a fiber optic wireless transmitter via fiber optic cable.

At a remote location (e.g., remote from the control center, remote from any source of electrical power), one or more remote nodes containing a RF receiver (e.g., a low power RF receiver such as a model CC2520 marketed by Texas Instruments, Inc.) is or are used to detect RF signals, at frequencies around, for example, about 2.4 GHz, which is a common frequency at which many wireless devices transmit and receive energy. The electrical output from the RF receiver may be amplified in an amplifier (e.g., model ADF7241 from Analog Devices, Inc.) that is used to drive a phase modulator within an interferometer, whose optical output is transmitted over long distances (e.g., kilometers) and then converted back to an electrical signal at a host node/control center, where electrical power is readily available. Bias energy for the amplifier is derived from a dedicated high power, DC optical signal (e.g., at 870 nm) from the (distantly located) host node and transmitted along an optical fiber. This signal is converted to an electrical current via a DC optical-to-electrical converter. Appropriate DC-DC conversion may then be performed on the converted signal to provide the necessary voltages to be used by the electronic components.

An interferometer is created, for example, in a Michelson configuration. One leg of the interferometer is created by an optical fiber extending from a fiber optic coupler to a reflector (e.g., a Faraday rotator mirror). In a second leg, a commercially available optical phase modulator (e.g., Model 21004570 from JDSU) is connected between a second fiber of the fiber optic coupler and a reflector (e.g., a Faraday rotator mirror), together serving as the sensing leg of the interferometer. In an alternate embodiment the entire interferometer is manufactured within a monolithic substrate (e.g., lithium niobate) using proton exchange or in-diffused titanium to create waveguides and includes a polarizer, a Y-junction splitter/combiner, one or more electro-optic phase modulators, and reflectors.

In certain exemplary embodiments of the present invention, an interrogator is located at the host node. The interrogator converts received optical intensity signals to an electrical output that may be further processed. The received signals can be retransmitted along an optical fiber to a remote RF transmitter.

RF transmission may be accomplished in three steps. First, the injection current of an optical light source (e.g., a laser) in the host node is modulated (e.g., by intensity or pulse width modulation) with the desired signal for transmission. Second, the output of the modulated optical light source (e.g., a modulated laser output) is transmitted optically along an all-optical cable. Third, the optical signal is received at the remote node (e.g., at the remote end of the cable), is converted to an electrical signal, and is then transmitted wirelessly via an RF transmitter (e.g., a low electrical power RF transmitter).

Certain aspects of the present invention relate to the construction and use of a electro-optic converter, which may include an interferometer that includes a phase modulator. The interferometer may include a series of optical waveguides formed in a lithium niobate substrate by proton exchange, having a y-junction with one input/output waveguide extending to a distal end and two legs extending to a proximal end. The phase modulator of the interferometer may take different forms. In one example, the phase modulator is a planar waveguide electro-optic phase modulator with at least two electrodes parallel to at least one leg of the interferometer. In another example, if the interferometer is fiber-based, including a fiber optic coupler and reflectors that are fabricated at the ends of optical fiber or are spliced to optical fiber, the phase modulator may be an electro-optic phase modulator including a fiber stretcher having an optical fiber wound around a piezo electric tube.

The interferometer may be a Michelson interferometer, for example, implemented in a Planar Light Circuit (PLC) or integrated optics device. In such a configuration, high coherence probe light arrives at a converter which divides the light (e.g., by means of a y-junction structure) into two roughly equal intensity paths (e.g., each path being a leg of the interferometer), each with a reflector at a distal end. Along one of these legs is an electro-optic phase modulator, including two electrodes oriented parallel to the waveguide. Electrical signals imposed between the electrodes cause the local index within the waveguide between the electrodes to change slightly, thereby changing the phase of the light passing through that leg in proportion to the electrical signal applied. The phases of the two legs are combined coherently at the y-junction which converts the relative phase between the legs to an intensity change that is transmitted back through the cable to the host node at a proximal end of the cable. This probe/interrogation can be done at baseband or as a demodulated signal wherein a carrier (e.g., phase) is imposed on the laser light before transmission into the cable and subsequently the carrier is mixed with the phase changes caused by the electro-optic signal, and the mixed optical signal is then demodulated at the demodulator.

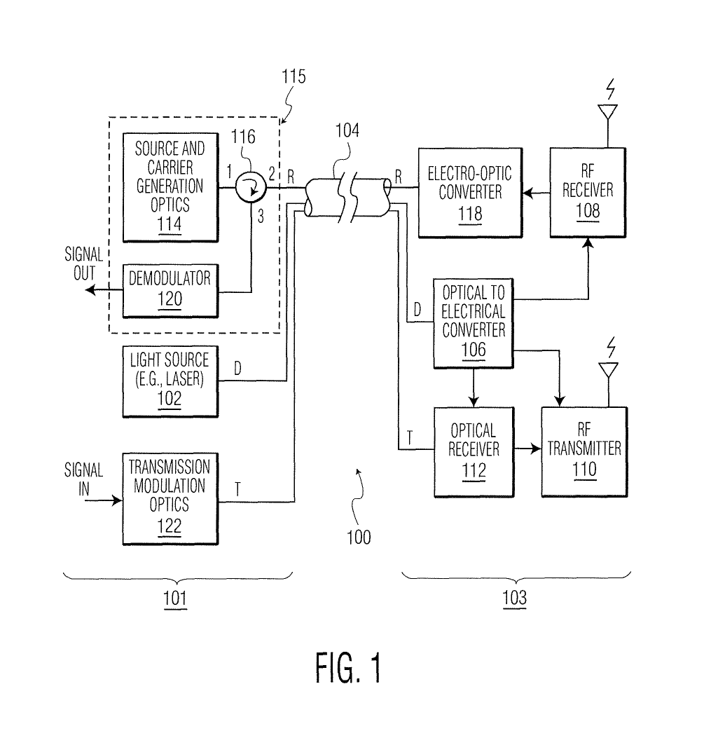

FIG. 1 is a system level block diagram of an exemplary fiber optic RF transceiver 100. Thus, in FIG. 1, examples of a “fiber optic receiver system”, a “fiber optic transmission system”, and a “fiber optic wireless transceiver”, within the scope of the present invention, are illustrated. Transceiver 100 includes a host node 101, a remote node 103 away from host node 101, and a fiber optic cable 104 between host node 101 and remote node 103. Of course, a plurality of remote nodes may be provided for communications between host node 101 and a plurality of remote nodes 103, and/or between ones of the remote nodes 103.

Input signals (e.g., voice and/or data labeled as “SIGNAL IN”) are injected into the transmission modulation optics 122. For example, optics 122 may receive an electrical signal (e.g., at baseband or another frequency), and converts the electrical signal to using a laser diode or other optical source. Thus, the output of transmission modulation optics 122 is a modulated optical output signal (e.g., a laser light signal) transmitted along optical fiber T. Fiber T is within fiber optic cable 104 (e.g., in one example, cable 104 is up to, or on the order of, 40 km long). At the distal end of fiber optic cable 104 is an optical receiver 112 (e.g., a high speed optical receiver) used to convert the modulated light from an optical intensity signal back to an electrical signal (e.g., a voltage signal). This electrical signal is transmitted to a RF transmitter 110 (e.g., a low electrical power RF transmitter) which transmits/retransmits the electrical signal wirelessly using a variety of methods (e.g., AM, FM, PSK, CDMA, etc.). The electrical signal received by RF transmitter 110 may be, for example, at baseband (or some other frequency), and as such, one skilled in the art will appreciate that RF transmitter 110 may include circuitry for “upconverting” the electrical signal prior to RF transmission.

An optical source 102 (e.g., a light source such as a laser, an SLED, an ASE source, etc.) at the host node 101 end of system 100 transmits high power (watts) of optical power into optical fiber D within cable 104. At the distal end (at remote node 103) of cable 104, this light is converted to an electrical signal using an optical-to-electrical converter 106 (e.g., a photodiode, a photdetector, etc) for providing electrical power (e.g., DC power) to various elements (e.g., an RF receiver, an RF transmitter, etc.). Optical to electrical converter 106 may desirably incorporate one or more voltage regulators. These regulators provide bias voltages to optical receiver 112 (e.g., a high speed optical receiver), RF transmitter 110 (e.g., a low power RF transmitter), electro-optic converter 118 (e.g., a high speed electro-optic converter), and RF receiver 108 (e.g., a low power RF receiver).

RF signals are received by RF receiver 108. RF receiver 108 may include elements such as a circuit for amplifying high frequency electrical signals and providing impedance matching, and an amplifier. The electrical signals received by RF receiver 108 (which may be downconverted, for example, to baseband using receiver 108 or some adjacent circuitry) are converted to optical intensity signals via electro-optical converter 118. The resultant optical intensity signals are transmitted via fiber R within fiber optic cable 104 to host node 101. At node 101 resides an interrogator 115 and a fiber optic circulator 116 having three ports labelled 1, 2, 3. In the example illustrated in FIG. 1, interrogator 115 includes a demodulator 120 (but may alternatively include, for example, a baseband receiver). The output of demodulator 120 (or interrogator 115) is the electrical output of this system (labeled as “SIGNAL OUT”). This “SIGNAL OUT” may take a wide variety of forms, for example: a baseband output to a communication switching system; an output to a loudspeaker; an output to a computer; an output to a local node; amongst others.

For the reception of the RF signals, the source and carrier generation optics 114 may include elements such as a long coherence length laser, a phase modulator, and a fiber optic circulator. The demodulator 120 may include a high speed photodiode, one or more stages of electrical amplifiers, an A/D converter, and an FPGA and/or digital signal processor for demodulating the received signal from RF receiver 108.

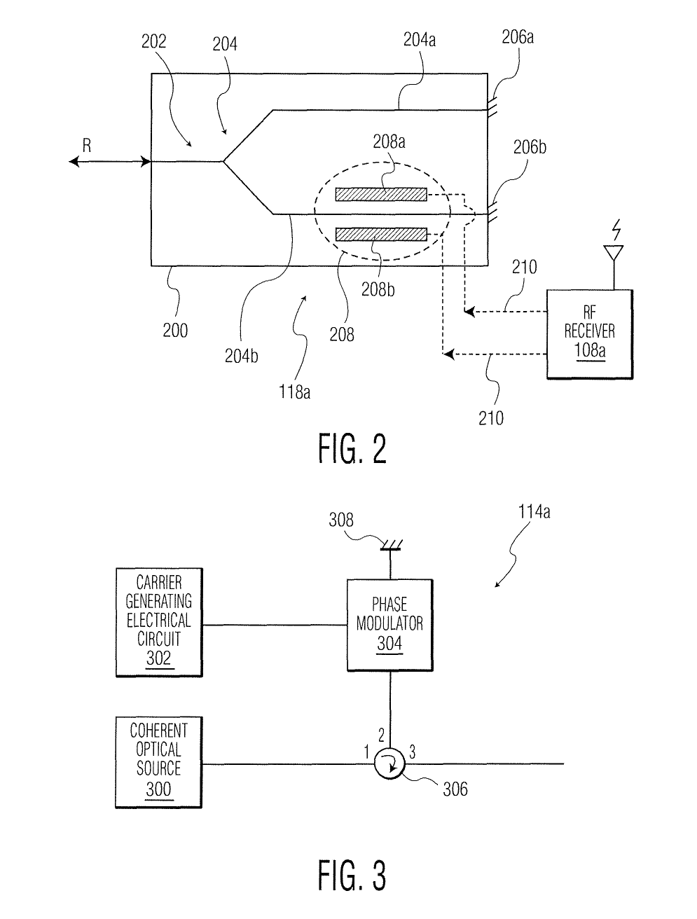

Thus, FIG. 1 provides a generic block diagram illustration of a system which includes elements of a fiber optic receiver system, a fiber optic transmission system, and/or a fiber optic transceiver. FIGS. 2-5 illustrate more detailed examples of certain elements shown in FIG. 1.

FIG. 2 is a detailed diagram of a high-speed electro-optical converter 118a (which is an example of high speed electro-optic converter 118 from FIG. 1), which in one example, may be provided within a substrate 200. The figure shows the device as a Michelson interferometer implemented in a Planar Light Circuit (PLC) or integrated optics device. High coherence probe light arrives at converter 118a along fiber R. Within converter 118a, the light arrives at a polarizing optical waveguide 202 (which, alternatively, may include a polarizer, indicated on the waveguide just below the tip of the arrow head from element 202) whereby the light is divided (by means of a y-junction structure 204) into two roughly equal intensity paths/arms 204a, 204b (where each path is a leg of the interferometer), each with a reflector 206a, 206b at the respective distal end. At least one of these legs of the interferometer includes an electro-optic phase modulator 208, which includes two electrodes 208a, 208b created parallel to waveguide 202.

Electrical voltage signals imposed between electrodes 208a, 208b cause the local index within waveguide 202 between electrodes 208a, 208b to change slightly, thereby changing the phase of the light passing through that leg in proportion to the electrical signal applied. The phase of the light in the two legs are recombined coherently at the y- junction structure 204 which converts the relative phase between the legs to an intensity change that is transmitted back through cable 104 (along fiber R) to host node 101. Reflectors 206a, 206b may simply be a reflective coating on the face of substrate 200 at the distal ends of the two waveguide arms 204a, 204b, or may be other discrete reflectors attached directly to substrate 200 or connected via optical fiber, such as Faraday rotator mirrors pigtailed to the ends of optical fiber leads, the proximal ends of which are pigtailed to the distal ends of each of the waveguides (the interferometer legs). Electrical signals are transmitted from a RF receiver 108a to electrodes 208a, 208b along a pair of respective signal lines 210.

FIG. 3 is a block diagram of source and carrier generation optics 114a (which is an example of source and carrier generation optics 114 from FIG. 1). Optics 114a include a high coherence length optical source 300 (e.g., a narrow line width laser). If a demodulated detection scheme is used, this circuit is used to generate a phase carrier (via carrier generating electrical circuit 302), which is ultimately mixed with the incoming signal (from source 300) at the high-speed electro-optic converter 118 (see FIG. 1). Continuous wave (CW) light from optical source 300 enters port 1 of a fiber optic circulator 306. The CW light leaves the circulator 306 along port 2. This light enters a high speed optical phase modulator 304 (e.g., lead zirconate titanate (PZT) fiber stretcher, tube, disk type, etc.) where an electrical signal from the carrier generating electrical circuit 302 causes the fiber to stretch in proportion to the electrical signal. This light is double-passed through phase modulator 304 by means of a reflector 308 (e.g., a Faraday rotator mirror) to enhance the modulation index, for example, by a factor of 2 (reducing the voltage/power requirements on the phase modulator 304 by 2 times). The modulated light leaves phase modulator 304 and re-enters optical circulator 306 via port 2, leaving circulator 306 again via port 3, only.

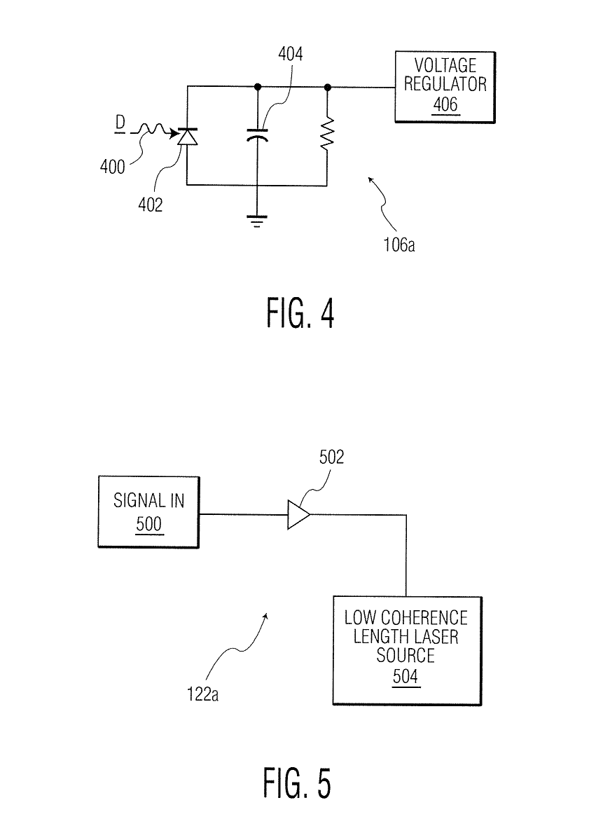

FIG. 4 shows details of a DC optical-to-electrical converter 106a (which is an example of converter 106 from FIG. 1) used to provide bias voltage to the active electronics at remote node 103 of FIG. 1, located at the distal end of cable 104. A photodetector 402 (e.g., a silicon p-n junction) is used to convert light 400 (optical) to an electrical current. This is followed by a low pass filter 404 (corner frequency on the order of 1 Hz is sufficient). Low pass filter 404 provides a DC output which is then modified and maintained by one or more commercially available voltage regulators 406.

FIG. 5 is a block diagram of transmission modulation optics 122a (which is an example of transmission modulation optics 122 from FIG. 1). The “SIGNAL IN” line 500 is an electrical signal for transmission. It can be voice, data, etc. This input signal is passed through an amplifier 502 to adjust voltage/current levels and provide the appropriate impedance matching to the laser modulation input. A low coherence laser source 504 is then intensity modulated by amplifier 502.

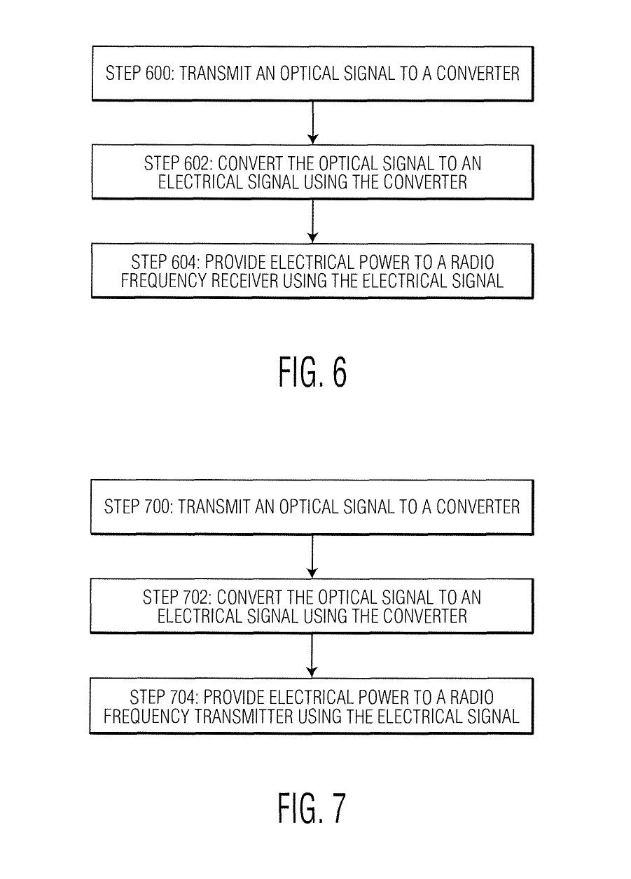

FIGS. 6-7 are flow diagrams illustrating methods of operating a fiber optic receiver system, and a fiber optic transmission system, respectively. As will be appreciated by those skilled in the art, the order of the steps in FIGS. 6-7 may be varied from that shown. Further, additional (or different) steps may be added within the scope of the present invention, as described herein.

Referring specifically to FIG. 6, a method of operating a fiber optic receiver system (such as a receiver included in the drawing shown in FIGS. 1-5) is provided. At step 600, an optical signal (e.g., a laser light signal such as a signal from optical source 102 shown in FIG. 1) is transmitted to a converter (e.g., converter 106 shown in FIG. 1. At step 602, the optical signal is converted to an electrical signal using the converter. At step 604, electrical power is provided to a radio frequency receiver (e.g., RF receiver 108 shown in FIG. 1, being electrically powered from converter 106), using the electrical signal.

Referring specifically to FIG. 7, a method of operating a fiber optic transmission system (such as a transmitter included in the drawing shown in FIGS. 1-5) is provided. At step 700, an optical signal (e.g., a laser light signal such as a signal from optical source 102 shown in FIG. 1) is transmitted to a converter (e.g., converter 106 shown in FIG. 1. At step 702, the optical signal is converted to an electrical signal using the converter. At step 704, electrical power is provided to a radio frequency transmitter (e.g., RF transmitter 110 shown in FIG. 1, being electrically powered from converter 106). using the electrical signal.

Although illustrated and described above with reference to certain specific embodiments, the present invention is nevertheless not intended to be limited to the details shown. Rather, various modifications may be made in the details within the scope and range of equivalents of the claims and without departing from the spirit of the invention.

What is claimed:

1. A fiber optic receiver system, the system comprising:
a host node including an optical source for transmitting an optical signal;
a remote node away from the host node for receiving the optical signal, the remote node including a radio frequency receiver, the remote node also including a converter for converting the optical signal into an electrical signal, the electrical signal providing electrical power for the radio frequency receiver; and
a fiber optic cable between the host node and the remote node, the fiber optic cable including an optical fiber for carrying the optical signal.

2. The fiber optic receiver system of claim 1 wherein the remote node also includes a radio frequency transmitter, wherein another optical signal is transmitted from the host node to the remote node, the another optical signal being converted to another electrical signal, the another electrical signal being transmitted wirelessly by the radio frequency transmitter.

3. The fiber optic receiver system of claim 1 wherein the remote node includes an electro-optic converter for converting an output electrical signal from the radio frequency receiver into an optical signal for transmission to the host node via the fiber optic cable.

4. The fiber optic receiver system of claim 3 wherein the electro-optic converter includes an interferometer for converting the output electrical signal from by the radio frequency receiver into the optical signal for transmission to the host node via the fiber optic cable.

5. The fiber optic receiver system of claim 4 wherein the interferometer is a Michelson interferometer, the interferometer including two optical legs, a phase modulator within at least one of the optical legs, and reflectors at a distal end of each of the optical legs.

6. A fiber optic wireless transceiver comprising:
a host node including: (a) source and carrier generation optics, (b) one or more optical phase demodulators, and (c) a laser; and
at least one remote node, each of the at least one remote nodes including (a) a radio frequency receiver including a circuit for amplifying high frequency electrical signals and providing impedance matching, and an amplifier; (b) an interferometer including two optical legs, a phase modulator within at least one of the optical legs, and reflectors at a distal end of each of the optical legs; (c) a DC optical-to-electrical power conversion circuit to convert incoming optical power to DC electrical power; and (d) a radio frequency transmitter.

7. The fiber optic wireless transceiver of claim 6 wherein the interferometer is a series of optical waveguides formed in a lithium niobate substrate by proton exchange, and includes a y-junction with one input/output waveguide extending to a distal end and two legs extending to a proximal end.

8. The fiber optic wireless transceiver of claim 6 wherein the phase modulator is a planar waveguide electro-optic phase modulator with at least two electrodes parallel to at least one leg of the interferometer.

9. The fiber optic wireless transceiver of claim 6 wherein the phase modulator is an electro-optic phase modulator including a fiber stretcher having an optical fiber wound around a piezoelectric tube.

10. The fiber optic wireless transceiver of claim 6 wherein the optical power conversion circuit consists of a photodetector.

11. The fiber optic wireless transceiver of claim 6 wherein the optical power conversion circuit consists of a photo detector, a voltage regulator, and one or more electrical DC-to-DC converters.

12. A fiber optic wireless transceiver comprising:
a host node including (a) source and carrier generation optics, (b) an optical phase demodulator, (c) a laser, and (d) transmission optics; and
at least one remote node, each remote node including: (a) an electrical radio frequency receiver including a circuit for amplifying high frequency electrical signals and providing impedance matching, and an amplifier; (b) an interferometer including two optical legs, a phase modulator within at least one of the optical legs, and reflectors at a distal end of each of the optical legs; (c) a DC optical-to-electrical power conversion circuit to convert incoming optical power to DC electrical power; (d) a radio frequency transmitter; and (e) a high-speed optical receiver.

13. A fiber optic receiver system, the system comprising:
an optical source for transmitting an optical signal;
a radio frequency receiver; and
a converter for converting the optical signal into an electrical signal, the electrical signal providing electrical power for the radio frequency receiver.

14. The fiber optic receiver system of claim 13 wherein the radio frequency receiver is provided at a remote location away from the optical source.

15. The fiber optic receiver system of claim 14 further comprising a radio frequency transmitter at the remote location.

16. The fiber optic receiver system of claim 14 wherein another optical signal is transmitted to the remote location, the another optical signal being converted to another electrical signal, the another electrical signal being transmitted wirelessly by the radio frequency transmitter.

17. The fiber optic receiver system of claim 13 further comprising an electro-optic converter at the remote location for converting another electrical signal received by the radio frequency receiver into another optical signal for transmission to another location.

18. A fiber optic transmission system, the system comprising:
an optical source for transmitting an optical signal;
a radio frequency transmitter; and
a converter for converting the optical signal into an electrical signal, the electrical signal providing electrical power for the radio frequency transmitter.

19. The fiber optic transmission system of claim 18 wherein the radio frequency transmitter is provided at a remote location away from the optical source.

20. The fiber optic transmission system of claim 19 further comprising a radio frequency receiver at the remote location.

21. The fiber optic receiver system of claim 20 further comprising an electro-optic converter at the remote location for converting another electrical signal received by the radio frequency receiver into another optical signal for transmission to another location.

22. The fiber optic receiver system of claim 19 wherein another optical signal is transmitted to the remote location, the another optical signal being converted to another electrical signal, the another electrical signal being transmitted wirelessly by the radio frequency transmitter.

23. A method of operating a fiber optic receiver system, the method comprising the steps of:
transmitting an optical signal to a converter;
converting the optical signal to an electrical signal using the converter; and
providing electrical power to a radio frequency receiver using the electrical signal.

24. The method of claim 23 further comprising the step of receiving another electrical signal at the radio frequency receiver, and converting the another electrical signal into another optical signal for transmission to another location.

25. The method of claim 23 further comprising the step of providing electrical power to a radio frequency transmitter using the optical signal transmitted from the optical source.

26. The method of claim 25 wherein the radio frequency transmitter is at a remote location away from the optical source, and wherein another optical signal is transmitted to the remote location, the another optical signal being converted to another electrical signal, the another electrical signal being transmitted wirelessly by the radio frequency transmitter.

27. A method of operating a fiber optic transmission system, the method comprising the steps of:
transmitting an optical signal to a converter;
converting the optical signal to an electrical signal using the converter; and
providing electrical power to a radio frequency transmitter using the electrical signal.

28. The method of claim 27 wherein the radio frequency transmitter is at a remote location away from the optical source, and wherein another optical signal is transmitted to the remote location, the another optical signal being converted to another electrical signal, the another electrical signal being transmitted wirelessly by the radio frequency transmitter.

29. The method of claim 28 further comprising the step of receiving another electrical signal at a radio frequency receiver at the remote location, and converting the another electrical signal into another optical signal for transmission to another location.

30. The method of claim 29 further comprising the step of providing electrical power to the radio frequency receiver using the optical signal transmitted from the optical source.
